(19) United States
(12) Patent Application Publication
(10) Pub. No.: US 2011/0057448 A1
(43) Pub. Date: Mar. 10, 2011

(54) Wave energy converters

(76) Inventor: Joseph Page, La Jolla, CA (US)

(21) Appl. No.: 12/584,561

(22) Filed: Sep. 8, 2009

(51) Int. Cl. F03B 13/18

(52) U.S. Cl. 290/53

(57) ABSTRACT

Wave energy, converters are arranged as a plurality of coupled float members arranged in a two dimensional array. Link couplings between any float member and its neighbors drive a mechanical system to convert the disorganized motion due to heaving and bobbing of the float member on the ocean's surface into linear reciprocating motion in orthogonal directions. Such linear reciprocating motion is converted to electricity in an induction system having a mover and a stator—either being an inductor, the other being a magnet. The array is preferably provided to cover large surface areas whereby energy from incident ocean waves is appreciably absorbed at the float member an converted to mechanical motion. The array may be held to the ocean floor by a mooring or anchor system immediately offshore or up to a few tens of kilometers from the shoreline. Electricity provided at the array may be conveyed to shore via a submarine power transmission cable where it may be distributed and consumed on the public grid.

### BACKGROUND OF THE INVENTION

1. Field

The following invention disclosure is generally concerned with wave energy converters and more specifically concerned with wave energy converters having an array of float members coupled together.

2. Prior Art

Ocean wave energy converters, or ‘WECs’, convert the kinetic energy in ocean surface waves to electrical energy which is in high demand by most of modern societies. The entire energy demands of the world population is contained in a very small area of the ocean's surface. The total annual average energy off the United States coastlines has been estimated (Bedard et al. 2005) at 2,100 Terawatts-hours or 2.1×10¹⁵ Wh.

Indeed, it is common to find an energy density of incoming ocean waves of up to 65 MW per mile of shoreline. Of course many authors have argued for considerably more by some calculations, but without consideration of the very high seas of Scotland or the Pacific Northwest of the United States, many calm oceans will nevertheless have appreciable energy densities contained in ocean surface waves.

Wave energy converters are most certainly not new, and the arts are full of important discoveries which date far back into times when energy derived from petroleum was quite inexpensive. However, as we have now certainly reached the point where interest in renewable or ‘green’ energy sources is at a considerable high, new important discoveries are being devised at a rapid pace. Society is determined to replace dirty energy sources such as coal and oil in favor of those more amenable for preservation of our wonderful planet.

An invention well known to related industries and a landmark patent is sometimes and herein called the ‘Salter Duck’. Entitled: “Apparatus and Method for Extracting

Wave Energy”, Steven Salter of Edinburgh presents his WEC in U.S. Pat. No. 3,928,967 issued in the winter of 1975. A plurality of movable members rotate about a horizontal axis—relative motion between members is converted to hydraulic, electrical, mechanical or chemical energy for ready use. Since this early comer, many ingenious grand schemes have also come forth. Those include but are not limited to the good inventions of the arts mentioned herefollowing.

In 1974, inventor J. Lapeyre of Louisiana USA devised and invented a wave energy converter in a unique configuration. A buoyant helical element deployed at the surface of the ocean is driven by high water in an ocean wave as a buoyant force acts upon the helix in a spatially biased manner. Rotation of the helix is first converted to rotational mechanical energy at a gearbox to improve rotational speeds preferred at practical generators where after high speed rotational energy is converted to a more useful form—electrical energy by an induction generator.

More recently, U.S. Pat. No. 7,525,214 was issued to Atilano Medina et al. in favor of Nova Ocean Energy Systems of Miami, Fla. Entitled “Wave Power System and Method for Generating Energy at Constant Rotational Speed at Variable Significant Wave Heights and Periods”, this approach is directed to reciprocating buoyant member which rises and falls causing a rotational motion on a shaft coupled to an electrical generator. Like the systems described by Atilano Medina's crew, many competing systems are based upon a floating buoy anchored to the sea floor.

In U.S. Pat. Nos. 3,818,705 and 3,818,704, entitled “Wave Energy Converter Array” and “Apparatus for Converting the Energy of Ocean Waves” respectively, Lapeyre presents most important aspects of high performance versions of WECs. In particular, the array nature of one version illustrates how a collection of repeat units cooperate to realize a high energy output where waves impart energy to a rotating mechanical system which drives an electrical generator to convert energy to electricity. This should be considered an important advance in WEC technologies.

Indeed, a great plurality of all WECs are based upon a float element rising and falling on waves to impart a driving force to a mechanical system which in turn produces electricity via induction. These include at least the following:

Hirsch, U.S. Pat. No. 7,199,481; Olson, U.S. Pat. No. 7,245,041; Zadig, US 2005/0084333; Dick, US 2005/0123353; Hirsch, US 2005/0099010; French, US 2004/0007880; Woodbridge, US 2004/0061338; Stewart et al, US 2005/0230206; Sabol et al, US 2005/0237775; Sabol et al, US 2005/0235641; Gerber et al, US 2003/0001392; Stewart et al, US 2007/0046027; Hirsch, US 2007/0132246; Kelly, US 2007/0080539; Hirsch US 2007/0228737; Taylor et al, US 2006/0208839; Bull et al, US 2007/0266704; Swart US 2008/0000224; Buffard et al, US 2008/0012344; Evans, US 2008/0211231; Agamloh et al, US 2008/0309088; Stewart, US 2009/0085357; Kelly et al, US 2009/0196693; Taylor, U.S. Pat. No. 4,434,375; Hirsch, U.S. Pat. No. 7,298,054, among others.

While these rising/falling float systems have important attributes and advantages, they tend to suffer considerably as their complexity, efficiency, durability among other aspects remains far from optimal and none have so far proven commercially viable. This is due in large part to the fact that a single absorber needs to be quite large to absorb appreciable amounts of wave energy. However large absorbers made appreciably durable against the harsh conditions of operation in a sea environment are extremely complex and expensive.

On the other hand, British inventor Richard Yemm has discovered and is currently experimenting with an interesting system he has named for the Greek word for sea snake—i.e. ‘Pelamis’. The Pelamis system is important because a plurality of elements cooperate together as wave energy absorbers. The Pelamis systems are distinct from most others as it is comprised of a plurality of cooperating float elements which operate together to drive a hydraulic system. Described in U.S. Pat. Nos. 6,476,511 and 7,443,045 and United States patent applications US 2007/0240624 and US 2006/0273593, these systems represent an important and rare advance in modern WECs as these were actually being deployed in Portugal in 2009—until a sour economy interrupted funding sources keeping the Pelamis project afloat.

We have seen similar arrays of float systems since as early as 1974 in U.S. Pat. No. 3,818,703 for example however, Yemm's systems are nearly reduced practice and are nearly operational while no other system has yet been demonstrated with a similar level of practicality. In any complete background relating to wave energy converters, one must point to the certain advantages of systems deploying a plurality of energy absorbers, such as those absorbers of Yemm.

Other important wave energy converters described in the arts and patents are distinguished by features and principles important to any system which could be considered a practical and deployable energy conversion system in a real-world scenario.

In one very important concept, inventors Stewart et al, teach of an active impedance matching system for a wave energy converter in the United States patent application US 2007/0261404 A1 filed Nov. 15, 2007. The device is actively ‘tuned’ to incident waves such that the absorption of energy by the system can be maximized as the device effective spring constant more closely matches the nature of incident waves. That is, an increase of acceleration to the system component is provided where waves of less energy stimulate the float. As such, the device is highly responsive to both large and small waves. This should be considered another important advance as the WEC is actively and in real-time adaptable to the instantaneous sea state to improve efficiency.

In yet another important teaching, Texas inventor Gray of Spring presents in the United States patent application US 2009/0066085 a system of two cooperating floats both coupled to a mechanical system where torques imparted by the floats are converted to rotation and finally electricity. The floats are designed to be stimulated by different parts of the waves (phase) and cooperate to deliver power to the mechanical system at various times in the wave cycle.

United States patent application US 2009/0183667 A1 is directed to special cooperation between a plurality of float members of a wave energy converter. In this teaching, the inventor instructs that there is an advantage to be had by reducing the total number of anchors required by an array system of WECs. An anchor sharing scheme provides a solid hold for the system in view of a preferred distribution. Indeed interaction and cooperation between pluralities of WEC floats is found in several system principles.

One very important wave energy converter is taught in U.S. Pat. No. 4,464,578 as a plurality of floats coupled together by rigid links at right angles with respect to incident waves. The system is provided with a ‘natural frequency’ which is tuned to frequencies of incoming waves to more efficiently cause absorption.

U.S. Pat. No. 7,100,481 of Apr. 3, 2007 present a plurality of cooperating floats which each interact with a different part of the wave cycle at any given time. A submerged axle and inductive coil and magnetic sleeve operate together to convert wave energy to electricity. The same inventor teaches further detail in similar related systems described in U.S. Pat. No. 7,298,054. A very similar system is presented independently by inventor Olson of Houston. Floats at the oceans surface on different parts of the wave (cycle) move cooperatively to turn a common axle which rotates an induction means to generate electricity.

One very curious contraption is a vessel powered by a wave energy converting system presented as U.S. Pat. No. 4,608,497, granted in 1986.

WECs of the arts suffer major deficiencies and as a result have not yet been deployed with much success. A first most important issue relates to absorption efficiency. While it feels intuitive that a large buoy rising on a wave crest receives considerable potential energy, indeed single buoy ‘point absorbers’ are less than ideal basis from which practical WECs can be realized. One easy way to understand this is to consider a comparison of the ocean surface before the wave falls incident on the buoy to the ocean surface after the wave passes the buoy. In a most efficient system, the incoming waves will interact with the absorbers such that the ocean surface is left quite calm and flat after the wave passes the device. It is only in such systems that waves strongly impart energy to the WEC. Most systems of the art contemplate repeat unit absorbers spatially distributed—however these are mere repeat failures as there is no cooperation between such point absorbers no matter their number.

Another major problem found in so many of the designs attempted, and a problem which continues to plague even the most modern devices, is durability. The Pelamis project suffers from failures of its hinging and linking mechanisms which continue to fail under the extreme stresses put on them. In addition, the ocean salt and other matter tend to very quickly attack exposed metal from which these components are made, leaving it with an unacceptably short lifetime.

Designers of so many WEC systems tend to make their machines quite large in size. This is due in part to the recognized need for the system to have an appreciable energy output. However, large submerged turning machines in salt water are extremely expensive to design and build. For this reason alone, many WECs never produce enough energy which can be sold for the amount the system cost. Unexpectedly short lifetimes exacerbate this problem considerably. It is for this reason that it becomes imperative in new WEC to eliminate complex large machinery exposed to sea conditions. Rather than build ever stronger and durable larger machines, it is desirable to build many inexpensive small ones which are easier to make more durable yet still collectively produce appreciable amounts of energy. It is another very important design consideration to eliminate exposure of metal components to seawater and even sea air.

While systems and inventions of the art are designed to achieve particular goals and objectives, some of those being no less than remarkable, these inventions of the art nevertheless include limitations which prevent uses in new ways now possible. Inventions of the art are not used and cannot be used to realize advantages and objectives of the teachings presented herefollowing.

### SUMMARY OF THE INVENTION

Comes now, Joseph Page with inventions of wave energy converters including devices having an array of float members each coupled to a neighbor.

### Summary

Wave energy converters are arranged as an array of cooperating floats each coupled to at least one neighbor—whereby motion between floats drives energy conversion mechanisms. In particular, two dimensional arrays of float members are formed rigid link couplings between float members permit free relative movements between them while coupling to mechanical systems to convert motion to electricity. Each float member moves independently on the water surface and heaves about under influence of passing waves. Links between float members freely pivot in two dimensions with respect a to float member's body to which they are coupled about a pivot point.

In most important versions, the end of a link is coupled to a mechanical system which converts motion in a spherical section to linear motions in two orthogonal directions. Linear mechanical motion is coupled to and drives an induction system to produce electricity. In some preferred versions, mechanical motion directly drives a coil or magnet with respect to the other, while in alternative systems, the rigid link first drives a hydraulic circuit and hydraulic pressure is thereafter used to stimulate an inductive system to generate electricity.

An array of floats may be held to the sea floor by a mooring or anchor system. Energy from passing waves is absorbed at the individual floats and converted to electricity. Electricity from the array may be conveyed to the shore by a submarine power transmission cable. Floats may be comprised of an outer shell or ‘hull’ part of a float member. Mechanical moving parts, subsystems and electronic components are arranged therein this enclosed space formed by the hull. Electrical interconnections between float members may include both power and control electronic transmission lines and these are sometimes preferably integrated within the rigid link shafts.

In certain important versions, a dynamic induction system provides an increase or decrease to motion resistance or ‘back EMF’ in response to the instantaneous sea state and particular wave conditions. Further, motion resistance between specific floats may be adjusted in a prescribed spatial arrangement in accordance with the array's orientation with respect to incident waves—or wave direction. That is, floats further from incoming waves may have a reduced motion resistance to improve energy absorption. In this way, the degree of energy absorption is ‘tuned’ to the sea state at any time.

It is a primary function of these energy systems to produce electricity from the motion of ocean waves. A fundamental difference between wave energy converters of the instant invention and those of the art can be found when considering its array nature and the interactions between coupled array elements.

Thus the invention stands in contrast to methods and devices known. The invention taught herein converts disorganized motion between neighbor floats into electricity by way of a unique coupled link and cooperating mechanical system. Wave energy converters of the art include many various configurations each having their advantage and defects—but none demonstrating the performance which can be realized in systems described herefollowing.

### Objectives of the Invention

It is a primary object of the invention to provide wave energy converters having a high energy absorption configuration.

It is an object of the invention to provide wave energy converters embodied as an array cooperating members.

It is a further object to provide wave energy converters of a plurality of coupled float members where relative motions between those members are converted to electricity by an induction system.

It is an object of the invention to produce clean, safe energy from the oceans and seas to free the world from further destruction caused by the burning of fossil fuels.

A better understanding can be had with reference to detailed description of preferred embodiments and with reference to appended drawings. Embodiments presented are particular ways to realize the invention and are not inclusive of all ways possible. Therefore, there may exist embodiments that do not deviate from the spirit and scope of this disclosure as set forth by appended claims, but do not appear here as specific examples. It will be appreciated that a great plurality of alternative versions are possible.

### BRIEF DESCRIPTION OF THE DRAWING FIGURES

These and other features, aspects, and advantages of the present invention will become better understood with regard to the following description, appended claims and drawings where:

FIG. 1 is a scenario diagram illustrating an array wave energy converter in accordance with these teachings;

FIG. 2 is a diagram illustrating a plurality of float elements and couplings therebetween;

FIG. 3 is a cross sectional view of an underwater working environment in which these systems are deployed;

FIG. 4 shows a most important relationship between neighboring float members and a rigid link which couples those float members;

FIG. 5 is a cross section diagram of an important preferred mechanical arrangement between a rigid link and float member of these systems;

FIG. 6 is a perspective drawing of a slide plate element in relation to a cage system which restricts the slide plate to motions in a plane;

FIGS. 7A, 7B and 7C illustrate positions of a slide and the motion relationships of coupled devices;

FIG. 8 illustrates a collection of linear induction systems coupled to a moving slide plate.

FIG. 9 presents a two dimensional array of induction systems coupled to a movable substrate;

FIG. 10 shows a system assembly where motion in a spherical section drives an array of linear inductor generators;

FIG. 11 illustrates a group of independent assemblies of FIG. 10 with a special spatial arrangement in support of one particular system array geometry;

FIG. 12 illustrates an important alternative simplification of reduced system parts;

FIG. 13 illustrates one important alternative array geometry of float members coupled to rigid links therebetween;

FIG. 14 similarly illustrates another important alternative array geometry of float members and their couplings to neighbors;

FIG. 15 describes an important particular embodiment of a float member construction;

FIG. 16 further presents the same (FIG. 15) embodiment in greater detail;

FIG. 17 shows an important special case scenario of motion between two neighbor float members;

FIG. 18 is an overhead diagram of coupled float members having special dual rigid link couplings;

FIG. 19 is a diagram which depicts two important subsystems which further enable important functionality; and

FIG. 20 is a diagram presenting a special alternative version including hydraulic elements coupled to slide plate.

### GLOSSARY OF SPECIAL TERMS

Throughout this disclosure, reference is made to some terms which may or may not be exactly defined in popular dictionaries as they are defined here. To provide a more precise disclosure, the following term definitions are presented with a view to clarity so that the true breadth and scope may be more readily appreciated. Although every attempt is made to be precise and thorough, it is a necessary condition that not all meanings associated with each term can be completely set forth. Accordingly, each term is intended to also include its common meaning which may be derived from general usage within the pertinent arts or by dictionary meaning. Where the presented definition is in conflict with a dictionary or arts definition, one must consider context of use and provide liberal discretion to arrive at an intended meaning. One will be well advised to error on the side of attaching broader meanings to terms used in order to fully appreciate the entire depth of the teaching and to understand all intended variations.

### Wave Energy Converter

A ‘wave energy converter’ is a system which converts the energy of ocean surface waves into electricity.

### Array

An ‘array’ is a plurality of like members arranged as a group—usually in two dimensions such as rows and columns to pave a surface area. While two dimensional arrays are of particular interest to the present teachings, it should not be lost that the special case of a single column of more than one member shall meet the meaning of ‘array’ for purposes of this definition.

### Float Member

‘Float member’ or sometimes merely ‘float’ means a body having buoyancy with respect to seawater—in general, a float member is comprised of a substantially enclosed space formed of a outer shell, housing or ‘hull’.

### Rigid Link

A ‘rigid link’ or sometimes herein ‘link’ is a coupling between a plurality of float members which permits relative motions between them. In general, a rigid link is coupled to a float member via a two (rotational) dimension joint or pivot.

### Induction Generator

An ‘induction generator’, or ‘generator’, or ‘induction system’ is comprised of a mover portion and a stator portion either being a magnet, the other being an inductor, whereby relative motions between the mover and stator produce electricity by induction.

### DESCRIPTION OF THE INVENTION

Wave energy converters are formed in accordance with the teaching as an array of point absorbers—or float members. Each float member is mechanically coupled to its neighbor(s) by way of a rigid link. A shaft extends between and passes through the hull of a float member at a pivot point. The pivot point permits rotational motion in two orthogonal dimensions such that the float member is permitted to heave, pitch, and roll under the influence of passing waves upon which they ride. Because the end of the link shaft is inside an enclosed space of the float member, it moves about relative to the axis of the float members; the tip lying within a spherical section at all times.

In most preferred embodiments, a link includes two ends—one each being coupled to a different float member. In this fashion, two float members are said to be ‘coupled neighbors’. Forces are conveyed to the interior of a float member by way of the rigid link shaft end. These forces may couple with and drive an electromechanical system to produce energy.

Arrays of float members may be large indeed and may cover significant swaths of sea surface. Indeed, it is not inconceivable that a single array cover between about 0.1 and 10 square kilometers. Because of the repetitive nature of the array configuration, float members may be added without practical limit, row after row, to achieve a desired level of performance. As a single kilometer of coastline may comprise up to or even more than 50 megawatts of energy, and efficiencies may only reach 10% in some versions, a 5 megawatt system may be the appreciable part of 1 kilometer long and possibly a few hundred meters wide.

In most preferred versions, a rigid link shaft end is coupled to a mechanical system which converts forces from the shaft into linear motion in either of two orthogonal directions. This linear motion drives an inductive electrical generator. Back electromotive forces (back EMF) resist the shaft motion and these forces may be increased or decreased (including dynamically) to be of a similar strength and nature in accordance with the shaft/float design (for example range of motion). Electrical outputs from a plurality of similar inductive systems may be consolidated into a single electrical output at a rectifier. Finally, an electrical output may be either passed directly into a power transmission system or relay passed to a neighbor float member for further conveyance in parallel with power from those devices to the power transmission line.

### PREFERRED EMBODIMENTS OF THE INVENTION

In accordance with each of preferred embodiments of the invention, wave energy converters arranged as an array plurality of coupled float members are provided. It will be appreciated that each of the embodiments described include an apparatus and that the apparatus of one preferred embodiment may be different than the apparatus of another embodiment. Accordingly, limitations read in one example should not be carried forward and implicitly assumed to be part of an alternative example.

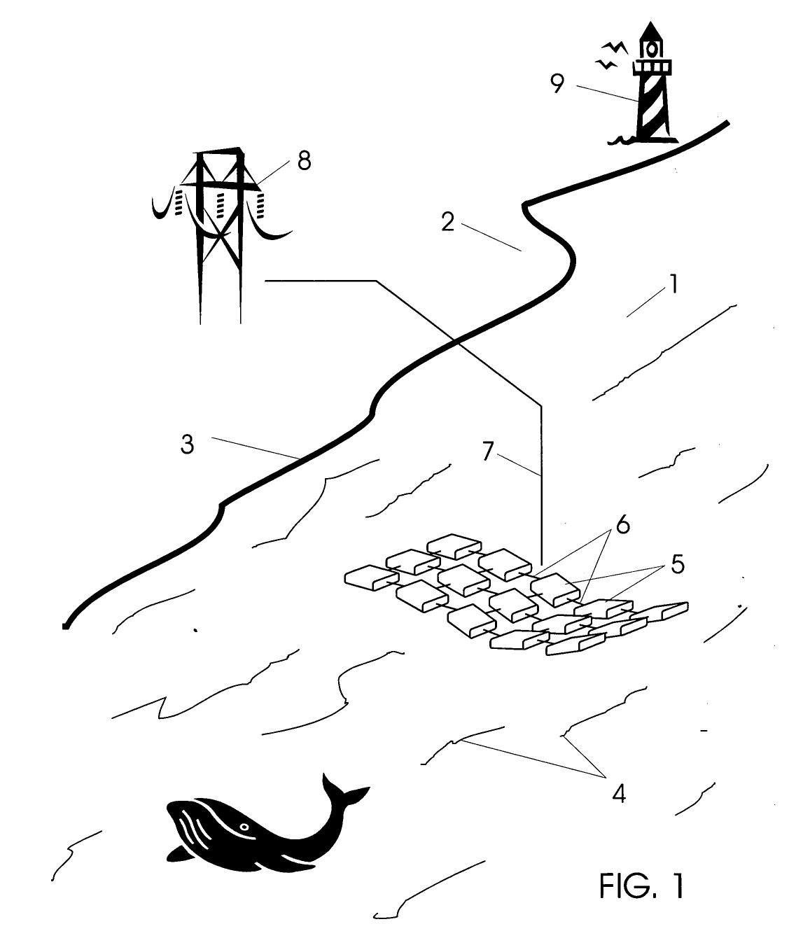

FIG. 1 illustrates the working environment of these systems—the surface of an ocean 1. The shore 2 meets the ocean's edge to form a shoreline 3. Natural waves 4 at the ocean's surface propagate towards land. An array of float members 5 are each coupled to at least one neighbor float by at least one rigid link 6. Electricity generated by relative motion between floats which drives an induction system or electrical generator, is conveyed by a submarine power transmission cable 7 to the shoreline and further into the electrical grid 8 power which may be distributed and consumed in a conventional manner—for example at a lighthouse 9. While not shown in this figure, it will be understood that the array may be held to the ocean floor by an anchor or mooring system to prevent it moving towards and landing on the shore.

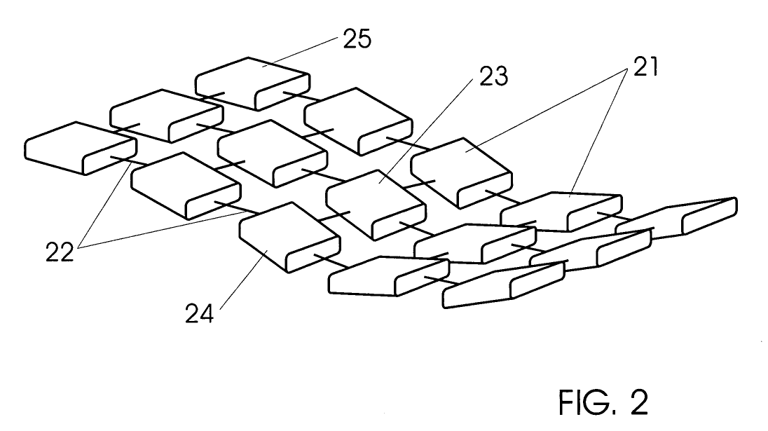

FIG. 2 illustrates wave energy converters in accordance with this disclosure arranged as an array in two orthogonal spatial dimensions—particularly an array of three columns by five rows of float members 21, each float member is coupled to its neighbors via rigid links 22. Floats may be characterized as either ‘middle’ floats, ‘edge’ floats, or ‘corner’ floats. A middle float 23 may be coupled via for links to four neighbors; and edge float 24 may be coupled via three links to three neighbors; and a corner float 25 may be coupled by two links to two neighbors.

While it is considered irregular, it remains possible that a float member is coupled to only one single neighbor in special versions. However, float members of these systems cannot operate in a standalone mode without at least one neighbor or couplings thereto—because it is the relative motions between any two floats which drives induction systems to produce electricity. Accordingly, it may be said that these float members are coupled to at least one neighbor.

While for simplicity the diagram depicts an array of 3×5, it should be appreciated that considerably larger arrays are likely to result in most practical systems. Indeed as in some typical parts of the ocean we can find a wave energy level of 65 megawatts per linear mile orthogonal to wave propagation direction, practical systems may be comprised of many hundreds or even thousands of float members and arrays of 100×20 would not be exceedingly large. These systems are highly scalable and overall size is not generally an important concern and has little effect on the operation of the array units.

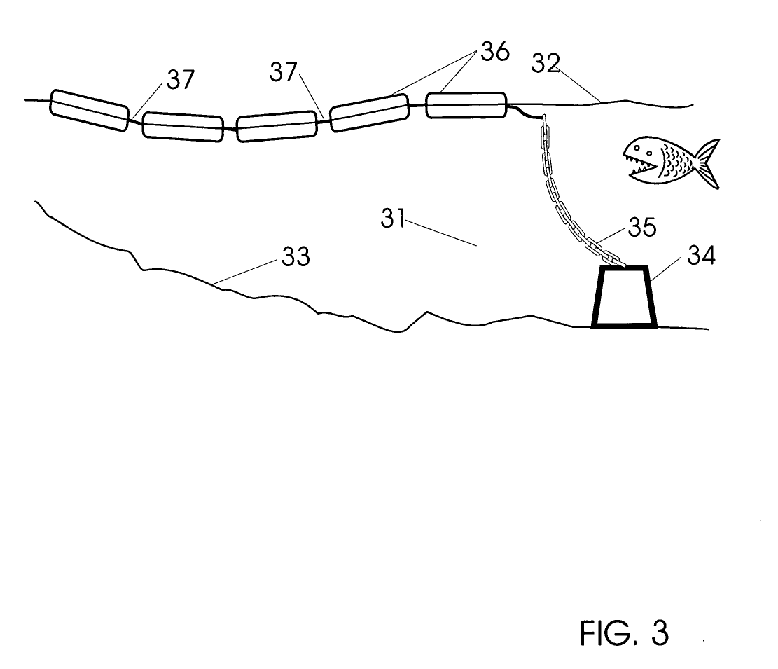

FIG. 3 illustrates a scenario diagram having a cross-sectional view of a wave energy converter array in accordance with this invention. Ocean water 31 is bounded by a surface 32 and a seafloor 33. There is water at the bottom of the ocean. Surface waves may travel great distances and carry energy with them toward a wave energy converter array. A mooring or anchor system 34 affixed firmly to the seafloor holds the wave energy converter array via a chain coupling 35 which is fastened to float members 36 by way of for example a bridle. Independently movable float members are linked to neighboring float members via rigid links 37. Rigid links are joined with the float members at a special pivot mechanism whereby floats may heave and roll and twist about under influence of ocean surface waves.

While it may be generally convenient to deploy these systems near a shoreline by way of an anchor system described, it is not essential to do so. Large arrays may be fashioned for use far (greater than 100 miles) from land. These systems may still be anchored to the seafloor via long cables or other similar tether means. In some special versions, it remains possible to deploy them has free-floating systems without anchor to the seafloor. However in most preferred practical versions, an anchor is used to keep the floating array stationery with respect to the ground beneath which it floats; and in most applications this is less than 10 miles from shore.

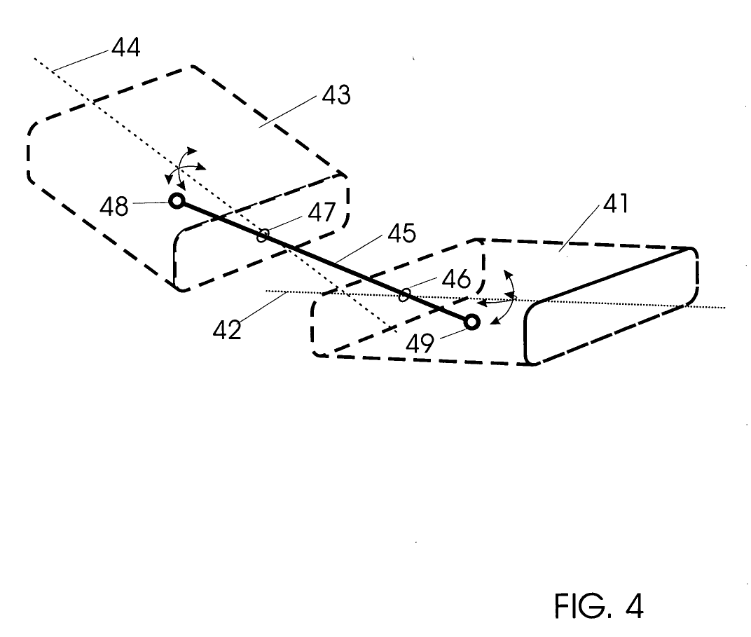

For a most complete understanding of these systems, one should have a detailed knowledge of motion between float members and links that couple them—the following presentation with reference to the drawing of FIG. 4 is directed to that objective. Careful and detailed consideration of this particular portion of the disclosure will improve an overall understanding of related coupled systems which follow.

FIG. 4 includes a drawing of two float members (neighbors) coupled by a rigid link. These floats are permitted free motion therebetween and they may rotate, pitch and roll about under the influence of incident waves upon which they ride at the ocean's surface—without regard for the position or motion of their neighbor. The first float member 41 has a longitudinal or symmetry axis 42. A second float member 43 similarly is distinct for its separate and independent longitudinal axis 44. Each float member is permitted free motion and their axes may move in two orthogonal directions in rotational movement about two discrete pivot points. Motion of these floats is a directed and controlled by the link element 45 which couples the first float member and to the second float member. The rigid link is coupled to both float members at a pivot point, i.e. the first float member is coupled at a pivot point 46 and the second float member is coupled at pivot point 47. In preferred versions a ‘pivot point’ is embodied as a heavy-duty ball joint which permits free motion (rotations) in two orthogonal dimensions.

These rigid links are further distinguished by the link ends, end 48 and end 49. The link may be formed of a heavy steal shaft and extend past the ball joint and into the enclosed space of the float member. The link ends moved in free space relative to the float member and indeed move about as the wave moves the float. A careful observer will note the tip or end of the shaft from which the link is comprised move in a spherical section. The diagram of FIG. 4 illustrates a coupling between two float members i.e. a rigid link. It will be appreciated that for clarity the diagram only includes two float members and one rigid link therebetween. Further it should be understood that the geometry shown in the diagrams includes four vertical sides for a single float; six sides in total when including a top and bottom. That is, in some preferred versions the float member is substantially a rectangularly symmetric body. In view of the diagram of FIG. 2, one will appreciate that each of the four sides of float members may have a similar or identical link affixed thereto by way of an independently movable ball joint.

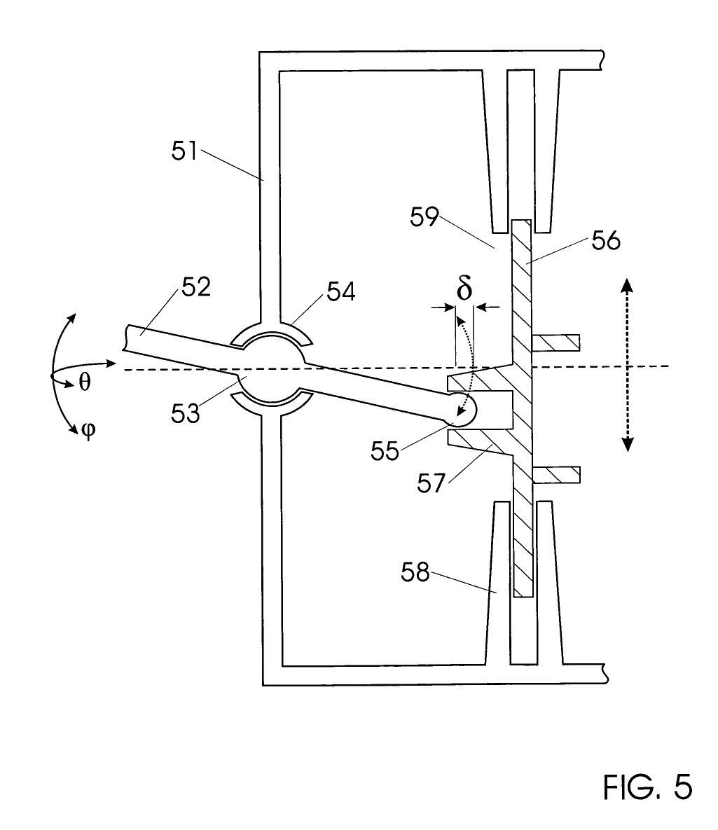

The diagram of FIG. 5 shows in a cross-sectional view a portion of a float member 51 and rigid link 52. A ‘ball joint’ coupling is formed between a spherical portion 53 of the rigid link and a socket portion 54 of the float member. While in some versions the socket may be formed integrally with the float member body or hull, in other important versions the ball joint socket portion is an independent member which is bolted or welded or otherwise fastened to the float member hull. In this configuration, the rigid link pivots in rotational dimensions (θ, φ) with respect to the float member. The link end 55 may be arranged as a sphere which drives a slide plate 56 by way of circularly cylindrical receiving socket 57. While the link and traces a curved path when moving, i.e. it always lies at some point within a sphere, this curved motion is converted to linear motion as the link end drives the slide plate which is restricted to movement within a plane. The slide plate rides in and is confined within a ‘cage’. The slide plate is permitted to move in two orthogonal directions in a plane, i.e. up-down, and left-right. The cage may have a circular aperture 59 which cooperates with the range of motion expected of the link end, while simultaneously providing maximum containment support of the slide plate.

No matter the motion of the rigid link which will be quite random under the influence of passing waves, the slide plate will only move within a plane as it is confined by the cage walls. The spherical link end rides confined in the slide plate receiving socket and slightly moves in and out by an amount ‘δ’ but causes the slide plate to move in a plane in response to rotations of the link shaft about the ball joint.

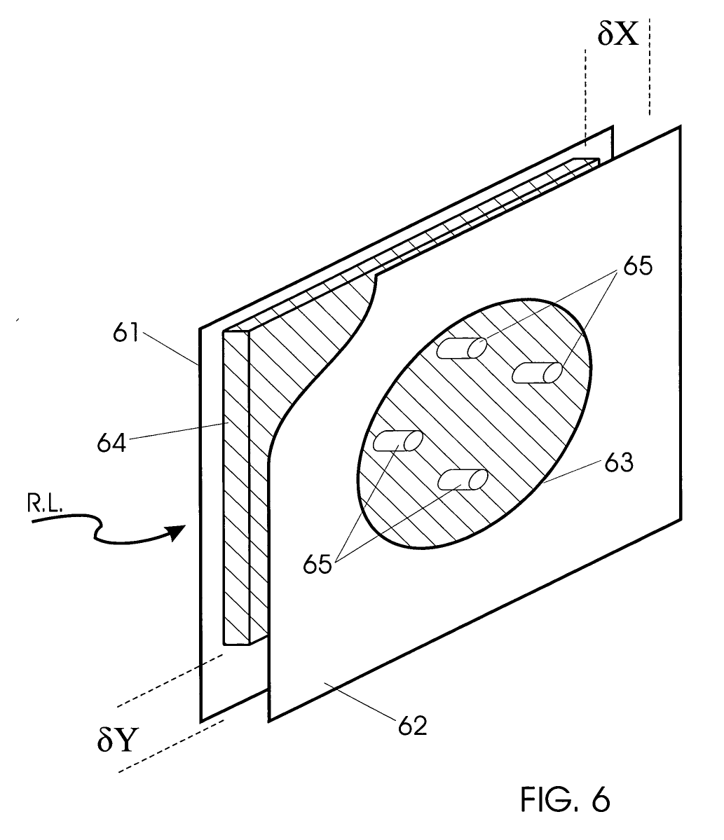

In the diagram, the left side of the slide plate is ‘driven’ side; the right side is the ‘drive’ side. That is, the slide plate is driven in two linear dimensions via the receiving socket as shown. However, the slide plate is further arranged with mechanical couplings which drive additional important subsystems. In this regard, it is important to further consider the nature of the slide plate and its motions as illustrated in FIG. 6.

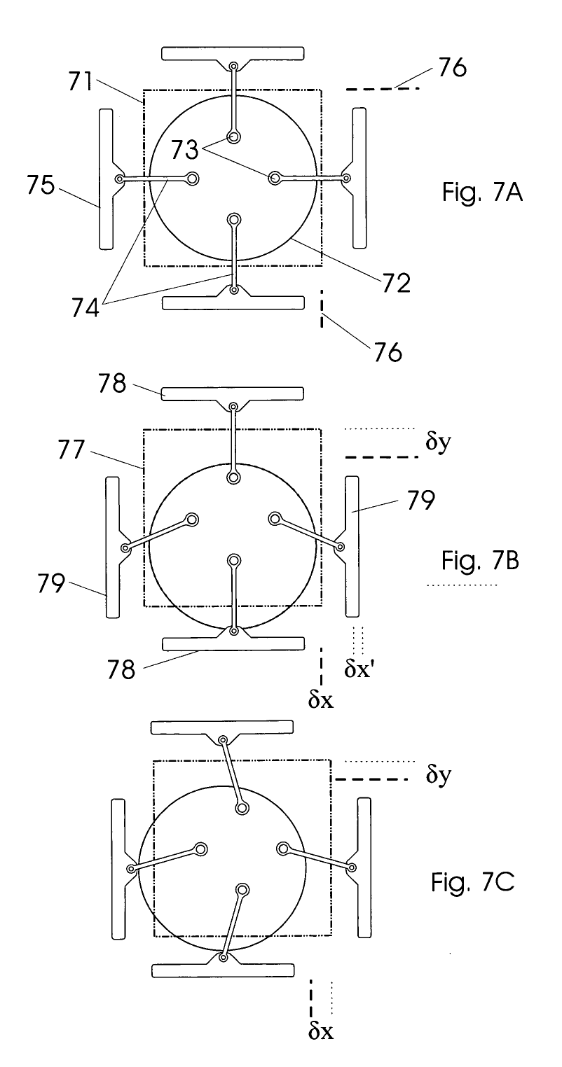

Slide plate cage is comprised of two parallel planar elements including: external plane 61 and internal plane 62. In some versions, each are provided a circular aperture 63. In this diagram, the rigid link ‘R.L.’ lies behind the structure and is out of view. Slide plate 64 readily slides within the confinement of the cage within the range depicted as ‘σx’ and ‘σy’ to cause a plurality of drive shafts 65, in this example four, to move accordingly. These drive shafts are provided to drive linear motion of coupled subsystems. Both planar elements may be integrated with a float member shell or ‘hull’. For example in one version, a float member is formed in two cooperating halves—and when assembled together may form a confinement cavity or ‘cage’ in which a slide plate may be contained. The four drive shafts are firmly affixed to the slide plate in a distribution as shown. In some alternative versions, a single drive shaft may have a plurality of connecting rods, usually two or four, multiplexed thereto. For clarity, the example developed here includes four shafts and four connecting rods one each for these four are associated with linear motion along the following directions: ‘x’, ‘−x’, ‘y’, ‘−y’. The drive shafts are preferably circular in cross section and to each of them a connecting rod is rotatably affixed whereby a first end of a connecting rod may travel with the slide plate in two directions, and a second end travels in a single linear motion. Such motion is readily apparent and easy to understand in consideration of FIGS. 7A-7C which illustrate motions of the slide plate in a plane and corresponding linear motion in the ‘x’, ‘−x’, ‘y’, ‘−y’ directions.

FIG. 7A illustrates a front side of a slide plate 71, the slide plate, movable in two orthogonal directions, i.e. within a plane, the slide plate is confined within a cage (not shown) which has a circular aperture 72. Four drive shaft elements 73 extend perpendicularly from the surface of the slide plate to which they are affixed. Connecting rods 74 are rotatably coupled to the drive shafts and each is further connected at a distal end via a pivot joint to a planar substrate element or ‘platter’ 75. The illustration further includes position reference marks 76 which make it easier to understand the relative position between the slide plate and the cage within which it moves. FIG. 7B illustrates motion of the slide plate in the vertical direction or along a ‘y’ axis or y-direction. A slide plate displacement of an amount σy in the y-direction, no displacement in x-direction i.e. σx=0, causes each of the four coupled platters to move under influence of their respective connecting rods. Each platter is restricted by mechanical means (not shown) to linear motion, and in preferred versions this linear motion is perpendicular to the platters primary surfaces.

Accordingly, horizontal platters 78 in the diagram are displaced in the vertical direction by an amount σy. Since vertical platters 79 are restricted to displacements in the horizontal direction only, the connecting rod rotates about the drive shaft to which they are connected and tend to pull each vertical platter toward the system axis slightly, i.e. an amount of σx′. A careful observer will note that although the slide plate only moves in the vertical direction, nevertheless small horizontal displacements (‘x’ and ‘−x’) are seen by the two vertical platters.

FIG. 7C illustrates a slide plate motion simultaneously up and to the right of the drawing page. While the slide plate is free to move within a plane, the four coupled platters can only move in either of four linear displacements ‘x’, ‘−x’, ‘y’, and ‘−y’ by mechanical restriction. FIG. 7C shows a displacement of the slide plate by an amount in the vertical direction by and by a similar amount in the horizontal direction 6x. All four platters while strictly moving on a line, each move respectively under drive from their corresponding connecting rods. In this way, slide plate motion within a plane is converted to strict linear motion in four directions. It is easy for engineers to see system component reductions as there are truly only two independent orthogonal linear directions ‘x’ and ‘y’. Accordingly it is merely a trivial engineering exercise to reduce the device to two drive shafts and two connecting rods to effect a nearly identical result. Indeed it is similarly possible to provide but a single drive shaft having either four or two connecting rods to drive platters in orthogonal linear motions. These reductions are fully anticipated. The example developed here is provided for ease of complete understanding and is currently the best mode known to the inventor.

With a firm understanding how heaving motion of a float member is converted to random motion of a shaft, and how that shaft may be coupled to drive a slide plate within a plane, and further by way of a plurality of drive shafts and connecting rods to linear motion in two orthogonal directions, one is properly disposed to consider converting such energy from ocean waves into electricity.

Platters described here are coupled to an induction system or electrical generator. Where motion drives either a magnet with respect to an inductor or coil of wire, or visa versa. In particular versions illustrated here, linear motion drives a magnet through a coil of wire to produce electricity by induction.

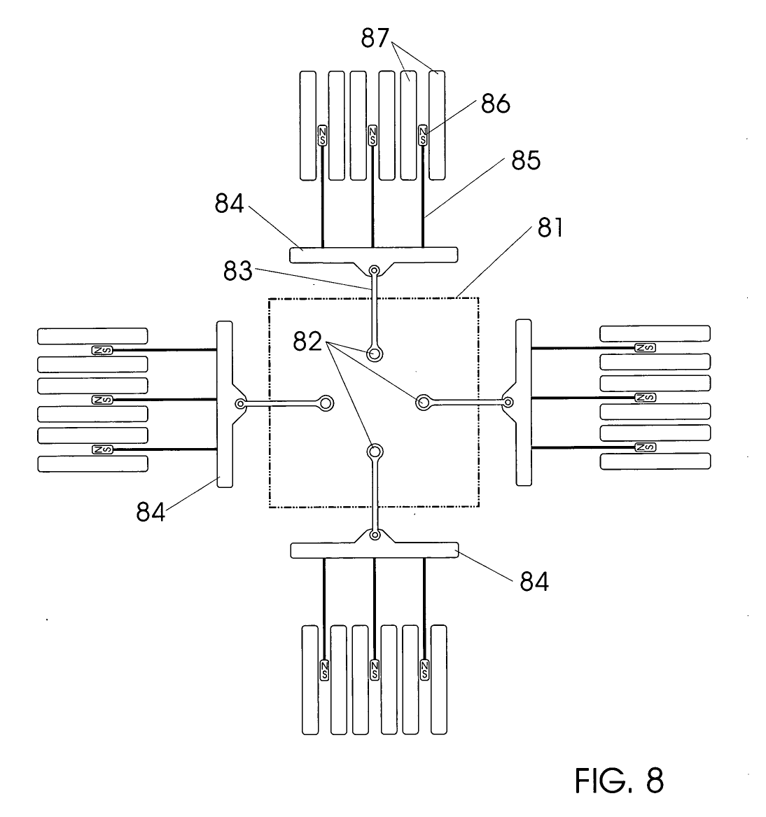

With reference to FIG. 8, slide plate 81, by way of a fixed drive shafts 82 and further coupled to connecting rods 83 causes mechanical energy in the form of linear motion to be conveyed to platters 84. A force which resists same motion is created by a ‘back EMF’ or ‘back electromotive force’ of an induction system to which the platters are connected.

Extension shaft 85 holds magnet 86 within the core of wire coil inductor 87. One will appreciate a significant redundancy as 12 individual inductor/magnet pairs are depicted in the diagram. While an inexperienced engineer might jump to question why not include a single strong magnet and inductor an important fixed system characteristic suggest a highly parallel nature of these inductive systems and additional discussion on that point is made in sections herefollowing. For the instant presentation, it will be sufficient to say a great plurality of separate coupled inductors is desirable. Indeed those shown in the drawing of FIG. 8 are only those in a single plane. However as the platter extends into the page as far as may be desirable, it will be appreciated that a platter can readily accommodate many additional parallel induction systems.

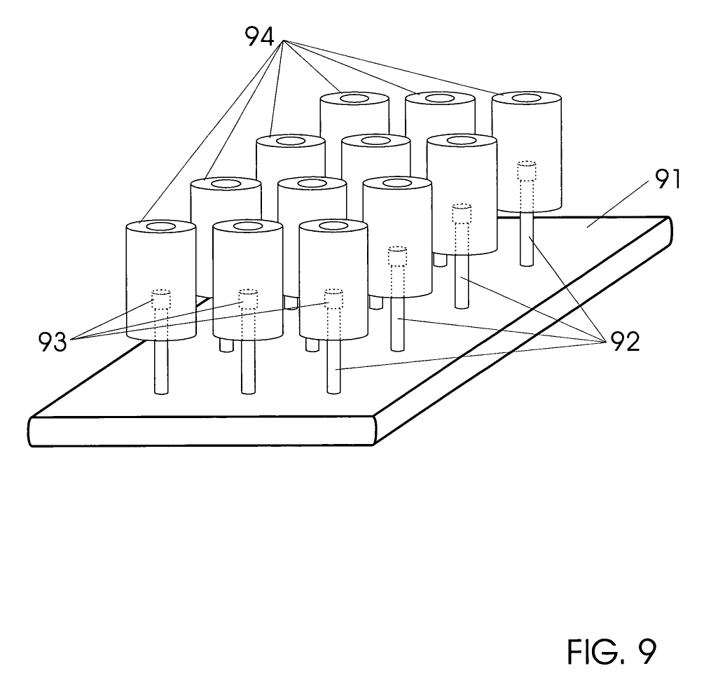

The perspective drawing of FIG. 9 which is a two-dimensional view of the platter 91 also shows how that platter can support an array of parallel induction systems. Extension shafts 92 are each terminated at one end with a magnet 93 shown in the diagram in phantom has they are disposed within the coil core. A 4×3 array of wire coils 94 provide induction means for the electrical generation system. It will be understood by those experts in the field that the coil array in this example fixed, or example mounted to the interior of the float member hull. The magnets are to reciprocate within the inductor core as they are driven linearly by an oscillating platter.

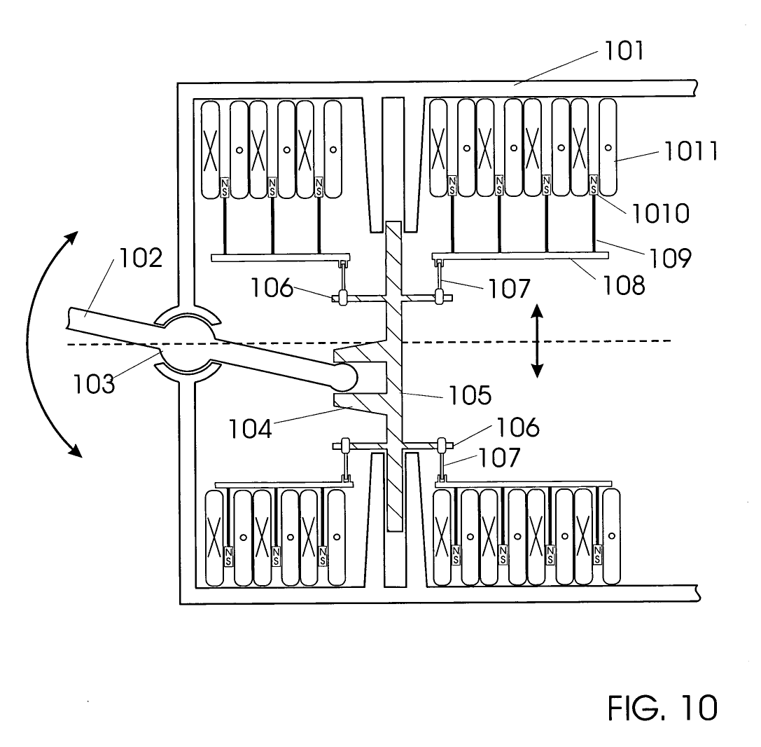

FIG. 10 illustrates a ¼ portion of some of these float members. Elements described in FIG. 4-9 are assembled together to form a basic unit portion of a float member. Specifically, float member outer shell or hull 101 is a durable and firm material which forms an enclosed space therewithin. In addition, the hull supports integration with a fixed portion of a ball type joint whereby a rigid link in the form of a shaft 102 may pivot at one point in two orthogonal rotational directions. Receiving socket 104 of the slide plate 105 receives therein the link end which may be terminated in a sphere of hardened material for example to create a low friction coupling. Motion of the link drives the slide plate to move within a plane as it is confined to a space in which it is held. Drive shafts 106 convey forces by way of connection rods 107 to platters 108. Platters are mechanically indexed to the interior surfaces of the float member such that they only move in a reciprocating linear motion. Extension shafts 109 extend from these platters and hold magnets 1010 in the core of inductors 1011. Forces applied to the rigid link tend to rotate it about the ball joint thus driving the slide plate. Motions of the slide plate cause magnets of the electrical generator to be displaced and reciprocate within the fixed inductors. Inductors may be coupled together to form a single current—at least for groups having same phase. Output from various sections having different phase may be combined via an electronic rectifier.

While the cross sectional diagram of FIG. 10 clearly shows in great detail the electro-mechanics associated with link shaft rotations in one dimension, limits of two dimensional drawings do not easily permit representation of workings in the orthogonal dimension (i.e. in and out of the figure). However, it is easy to understand that systems (from the connection rods to the inductors) identical to those shown but disposed 90° relative to the one in the diagram operate to convert shaft rotation to electrical energy where the shaft rotations about the pivot point are in an orthogonal dimension. In other words, the figure does not show a generator and mechanics associated with link shaft movements (rotation) into and out of the drawing page.

As described and illustrated in FIG. 2 and others, these wave energy converters include an array of float members, each float member being coupled to at least one neighbor, and in many cases, coupled to four neighbors. Where a single float member is coupled to four neighbors, then the system shown in FIG. 10 is a ‘repeat unit’ reproduced four times. Each of the repeat units are arranged with an orientation to support the spatial distribution of float members of the system array. That is, with respect to link shaft locations necessary to support the nature of the array, these repeat units may be integrated with or mounted within a float member enclosure accordingly. In one example which supports the two dimensional array of rectangularly symmetric float members of six sides each, four of such repeat units are arranged, each at right angles with respect to two others.

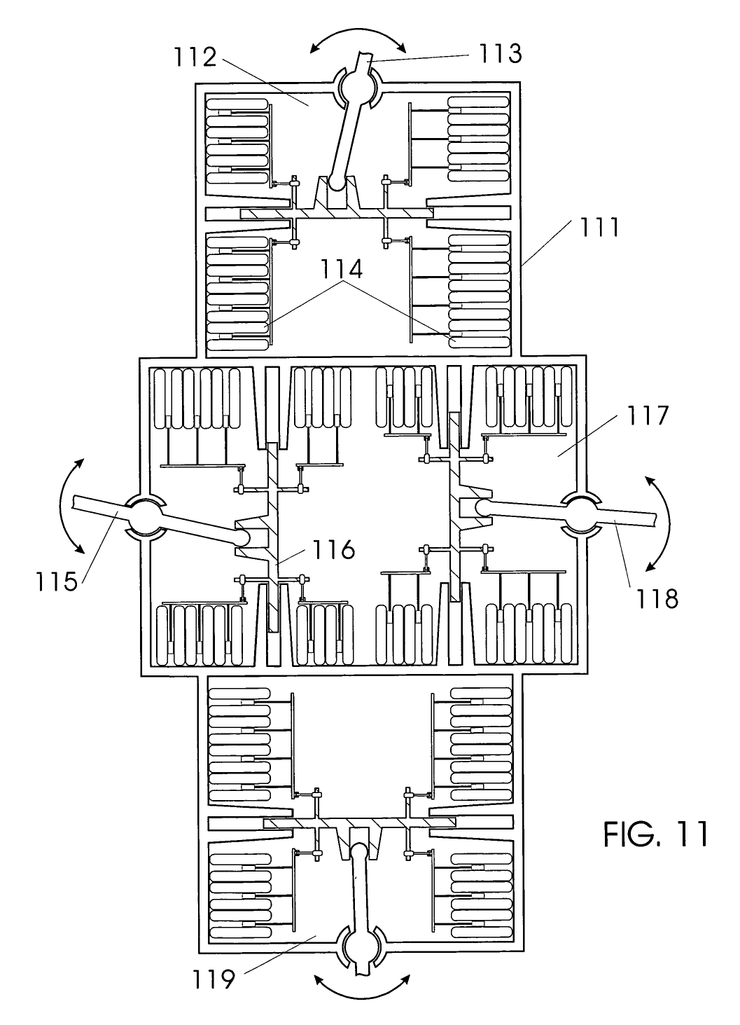

FIG. 11 illustrates. A float member shell 111 forming an enclosed space which includes therein four mechanically driven electric generators—each being stimulated by two dimensional shaft rotations about a single pivot point. One ‘quadrant’ 112 of the float member is driven by link shaft 113 which produces electricity by induction at electric generators 114. A separate and independently movable link shaft 115 drives slide plate 116 which causes reciprocal motion of magnets in inductor cores. An opposing system similarly within enclosed space 117 formed by the float member shell identically generates electricity in response to rotational forces applied at link shaft 118. Of course the system within enclosed space 119 performs similarly.

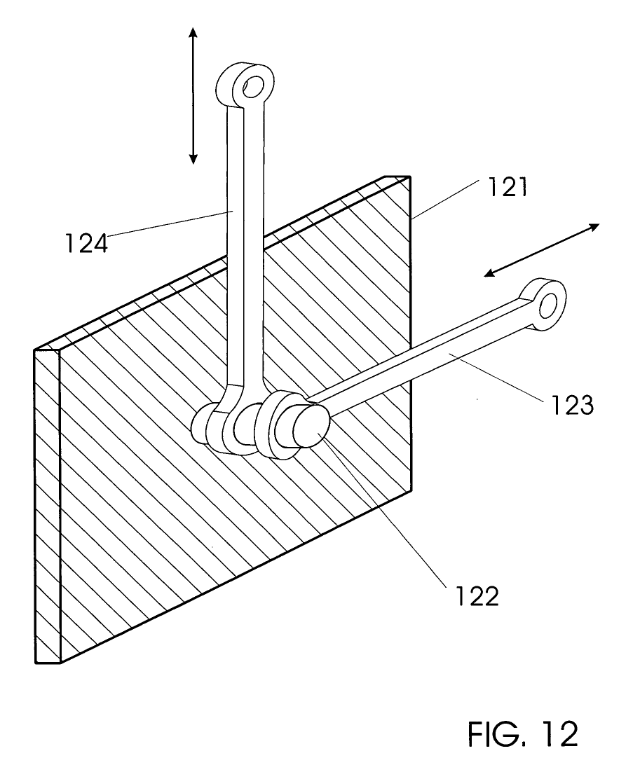

FIG. 12 illustrates an important alternative. If a slide plate 121 is coupled by two connecting rods on a single drive shaft 122 as shown, it is possible to couple all forces from the link by way of the slide plate to linear motion in an x-direction and orthogonal y-direction. Connecting rod 123 may be provided to drive a platter along x and −x, while connecting rod 124 may be coupled to drive separate independent platter in y, −y. Such reductions should not be viewed as ‘inventive’ improvements to the teachings here, but rather merely careful engineering. These improvements are anticipated however preferred embodiments are more easily understood when drawn without such reductions.

It is also important to comment on the shapes of float numbers and link configurations. While preferred embodiments include float members substantially rectangularly cylindrical, or substantially circularly cylindrical, other important shapes may offer additional or different advantages. Accordingly, the precise geometry of float members is not to be considered an enabling feature of the invention and many alternatives will certainly cooperate with fundamental principles taught here—where wave energy converters are comprised of an array of float members, each coupled to at least one neighbor via at least one rigid link.

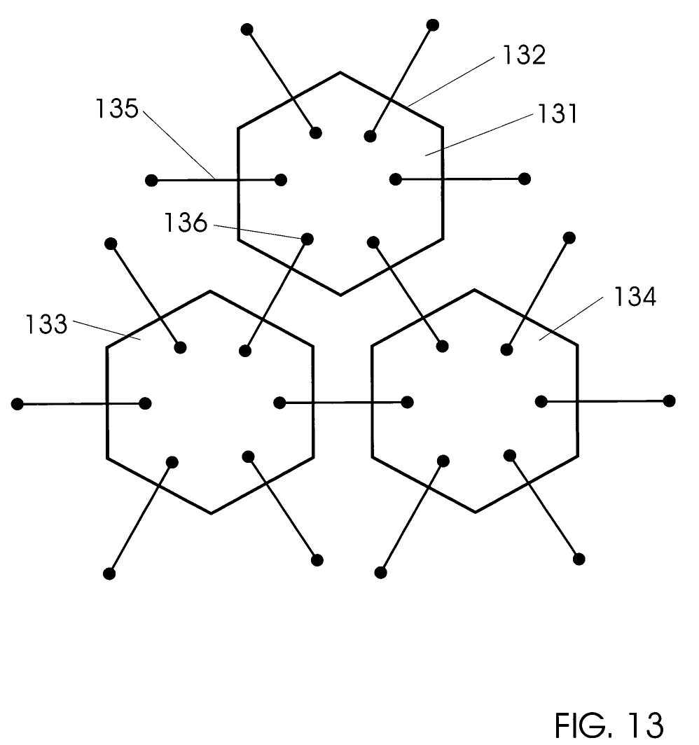

In one illustrative example of an alternative array and alternative geometry, FIG. 13 depicts an array of float members, 131 having a vertical symmetry axis and hexagon or six sided (vertical sides) periphery where each side 132 is coupled to a neighboring float member, neighbor float 133, and neighbor float 134 by way of a rigid link 135. The rigid link passes through the float member side at a two dimensional pivot or ‘ball joint’ and extends into enclosed space of the float member where the link end 136 may be mechanically coupled to a system in which mechanical motion is converted to electrical energy.

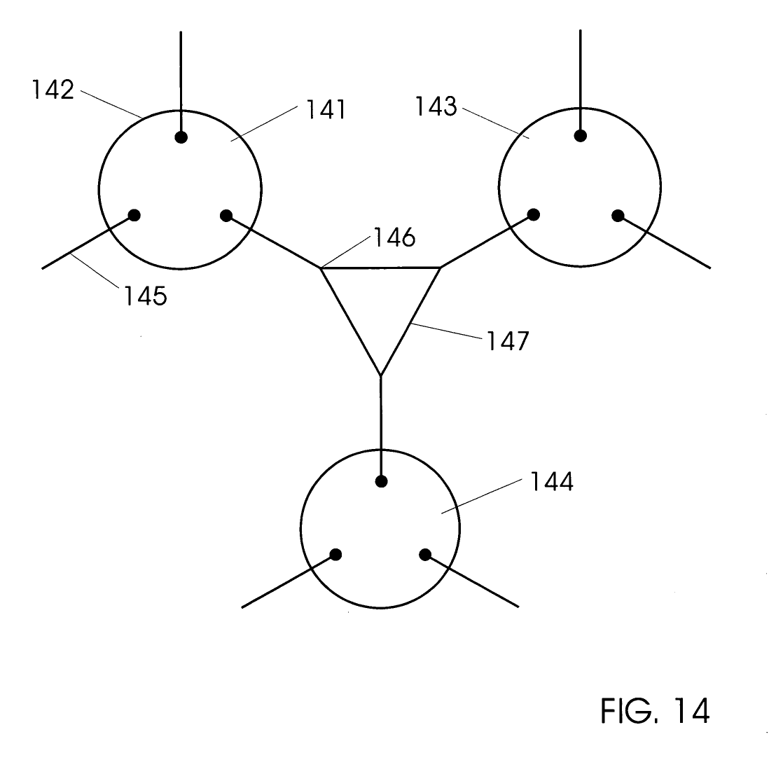

While the rigid links heretofore presented are characterized as a simple linear shaft of two ends, and support for two ball joint type couplings—other possible configurations are anticipated and these cooperate well with certain arrays of particular geometry. FIG. 14 is a diagram of an array of float members arranged as in this example version, a float member 141 is arranged as a circularly symmetric cylinder—the ‘sidewall’ having a circular periphery 142. Neighbor float members, float member 143 and float member 144. A terminal portion, the link end, of rigid link 145 is similar to those illustrated in previously presented versions whereby an end extends into the enclosed space of a float member. However, the rigid link of this version may further include a junction 146 and for example a multiplex section 147 whereby more than one additional terminal portions are coupled to neighboring float members, e.g. link shaft 148 and link shaft 149. In this version, it is important to note that a single rigid link may be coupled to more than two float members and performance of the link with respect to its conveyance of forces and energy to any float member will depend upon the actions of two so coupled neighbors rather than one single float member. Those alternative versions are anticipated. The reader will be advised that many alternative geometries will accomplish the identical result and effect. Variations to specific geometry in this regard will not traverse the essential elements and inventive nature of devices first taught here where a rigid link coupled to a plurality of float members that pivot in two dimensions at a point near where the link passes through the side wall of coupled float members. That is to say, a most important aspect of the invention relates to the nature of the link pivot with respect to the action of the float member—but not any particular array geometry. That said, it can be shown that same array geometries will have favorable performance advantages in comparison to others. Some of these performance advantages will be due to the nature of waves upon which these arrays are deployed. That is, there may be special cooperation between a particular geometry and a particular sea state. Accordingly, some geometries will perform better in some locations/conditions. But in all cases, the variances in geometry should be considered subsets of teachings described and first presented here without distinction.

With a clear understanding of variations possible with regard to float member shapes and configurations, as well as rigid link shapes and configurations, it is important to direct attention to special aspects of float member construction. Of course most modern naval architects will completely understand the advantages of constructing boats from polymer materials—currently this is a most common construction materials, it is likewise beneficial in many parallel regards that construction of the float members taught here be of similar polymer materials. Superior strength and durability and the very inexpensive nature of such construction, in special view of molding (i.e. reproduction of many identical parts) further suggest use of polymer materials. Accordingly, some most important versions of float members of these wave energy converter arrays are made of polymer resin in a molding process.

In some important alternatives, other materials and manner of construction are more suitable. One important system performance aspect relates to durability and maintenance. While float member hulls constructed of polymers are great for the sea environment, they are nevertheless exposed to catastrophic failure due to heavy impact forces. Further, these materials are sometimes susceptible to failures due to aging and cracking over time. Other limits of polymers in view of the particular nature of these waves energy converters which are to be deployed for extended periods at the surface of the ocean suggests alternative construction materials and technique for certain highest durability versions.

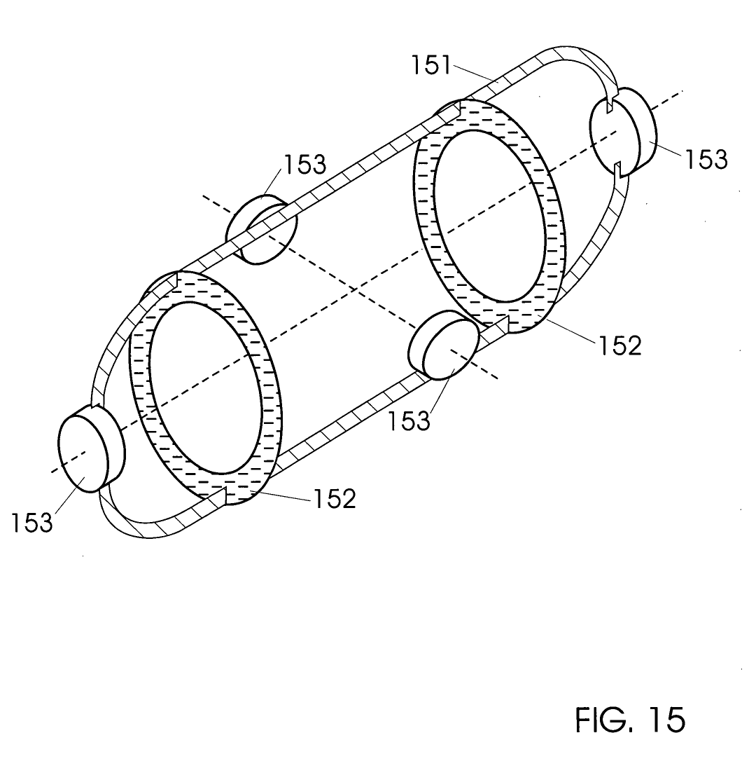

One important example version suitable for extended deployment at sea includes a float member of a highly flexible material. Rubber, rubber compounds, synthetic textiles coated with abrasion resistant synthetic rubber, among others provide a high-performance solution. However, as mechanical systems presented depend in part on good spatial alignment and coupling, i.e. it is undesirable for a link shaft end to pull free from the receiving socket of a slide plate, the float walls and in particular the stability of the ball joint with respect to the inner works should not be subject to too much flex. As such, one important solution is to construct a rigid skeleton to hold fast the ball joints and inner works, but to fasten there about a flexible rubberlike skin. The illustration of FIG. 15 presents a rigid skeleton of structure having longitudinal stringers 151 and circumferential bulkheads 152. These provide a rigid frame structure and support to maintain the spatial alignment and position of each ball joint seat portion 153. The stringers and bulkheads may be fabricated of high-performance corrosion resistant metallic materials such as aluminum, or may alternatively be formed of carbon fiber based composites or even simple fiberglass based polymer systems. To the skeleton, a skin of very tough highly durable materials such as synthetic rubber described above may be applied. In one preferred embodiment, two halves form a mating ‘clamshell’ arrangement—when assembled together, these provide a most durable enclosure to contain both the skeleton structure and the inner works described in FIGS. 4-9.

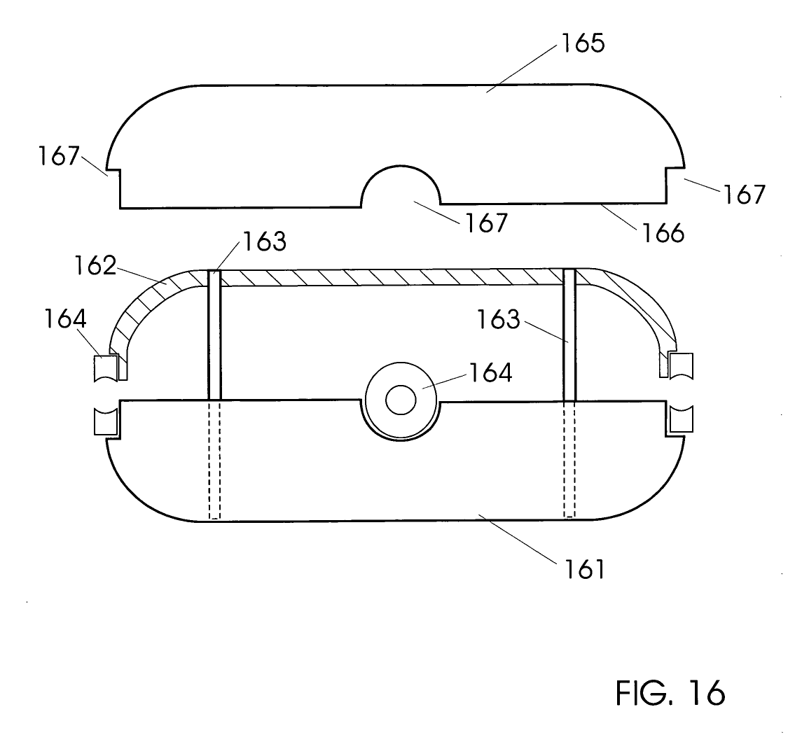

FIG. 16 illustrates. A first portion, a ‘bottom’ portion 161 formed of a very highly durable flexible material such as a synthetic rubber compound is molded or otherwise shaped to closely couple with and fasten to the skeletal frame including longitudinal stringer elements 162 and transverse bulkhead elements 163. A plurality of ball joint seats 164 are disposed about the midsection of the system and are arranged to receive therein a spherical portion of a link to form a two-dimensional pivot joint. A second portion of the clamshell arrangement, a top portion 165 is similarly made of very highly durable synthetic rubber compound for example and forms a mating pair with the bottom portion including a peripheral edge 166 with cut-out portions 167 to fit against and integrate with the ball joints. When tightly mated with the bottom portion, the clamshell halves form a substantially enclosed space and watertight seal. For most durable seals, adhesives such as a polyurethane known as ‘5200’ from 3M Co. forms a strong watertight bond. In addition, the peripheral edge may be provided with additional support for fastening such as holes and seats for nut and bolt type fasteners for example.

The special version of float members depicted in FIGS. 15-16 is particularly important for some high-performance systems. One important aspect of these versions relates to array orientation with respect to incident waves. The float member depicted has a longitudinal axis a transverse axis. It can be preferred to orient float members with either of these axes aligned with the direction of wave propagation to achieve more or less vigorous motion for example or to stimulate certain preferred oscillation modes. The nature of the sea or sea state will sometimes warrant an alignment in which an incoming ways maximizes float motion. For example, in systems deployed in seas having a generally calm state. In some rough seas, it may be necessary to align the array such that float members more readily pass over waves, the float member having already received a maximum energy transfer from the passing wave. In oceans of highest wave activity, it may be preferred to provide float members having a clear directional bias and even in some cases a shaped bottom to more readily ride over and/or pierce incoming waves.

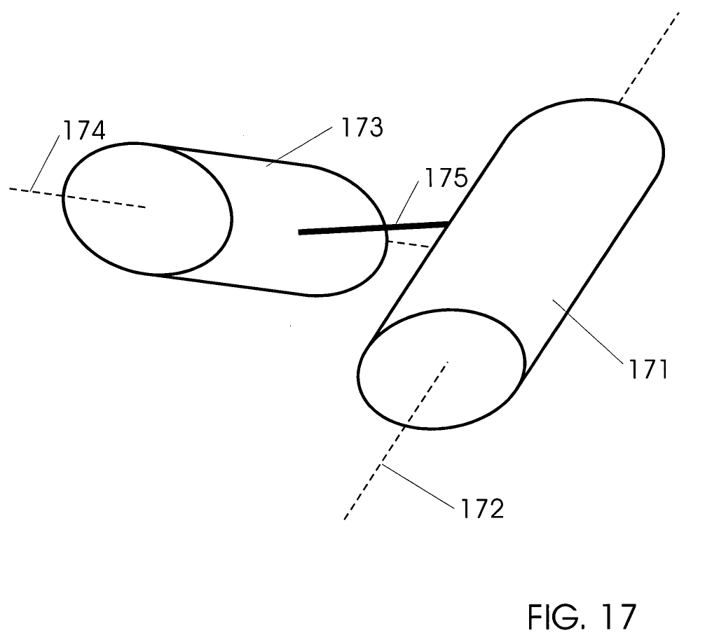

Another very important arrangement unique to this disclosure relates to certain oscillation modes and specific array geometries. In certain geometries which largely depend upon float separation distance; float length; an angle of incidence of incoming waves among others, an immediately adjacent neighbor float may pitch out of phase. This is illustrated in the diagram of FIG. 17. A first float member 171 having a longitudinal axis 172 is pitched downwardly at the front. A second float member 173 is an immediate lateral neighbor of float member 171 and is in a ‘pitch-up’ state with its longitudinal axis 174 indicating such. Rigid link 175 which couples of these two floats together permits free pitching about its ball joints (two), however such float member motion will not stimulate any corresponding motion to the slight plate (Please refer to FIG. 5). Accordingly, when arrays are designed with certain physical dimensions and of these arrays are used in a sea state which tends to strongly stimulate pitching type oscillations of the array float members, than it is preferred to modify the link geometries for lateral float member coupling.

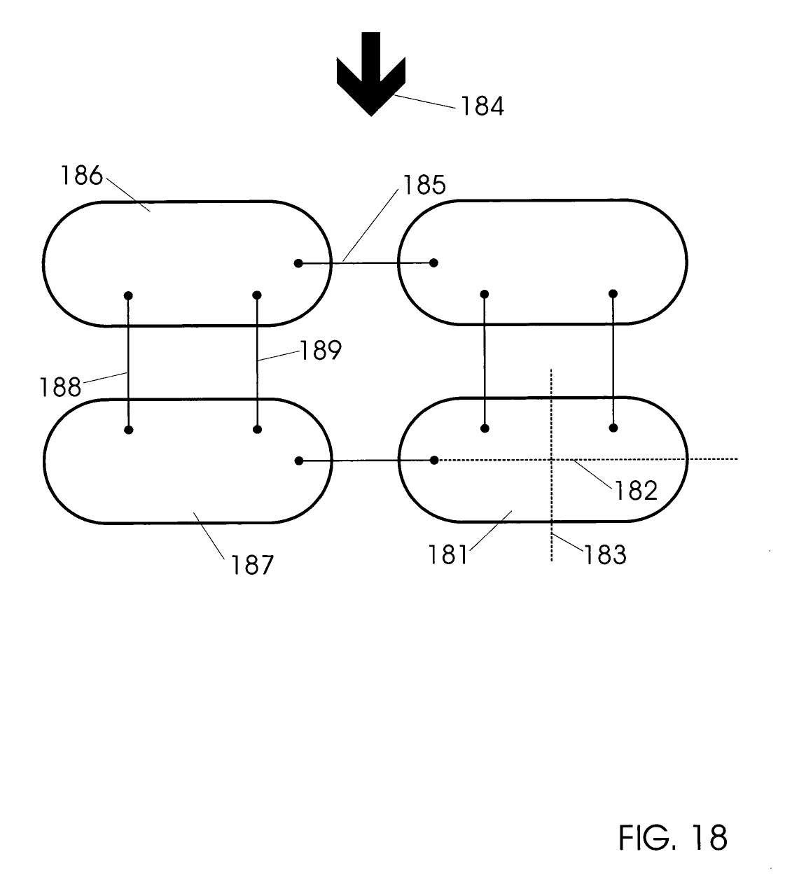

FIG. 18 shows a preferred type of link arrangement between neighbor floats for systems subject to comparatively high degree of pitch oscillations. Float member 181 has a longitudinal axis 182 and transverse axis 183, the length of the float member is approximately twice that of its width. The array is aligned such that incoming waves 184 are incident upon the broadside of float members. One type of rigid link 185 is same as those described previously in this disclosure. Another type of float member coupling specifically designed for systems tending to have increased pitch activity includes two separate but cooperating links between same float members. Float member 186 and its immediate neighbor float member 187 are coupled by two parallel links, link 188 and link 189. When float member 186 pitches in a direction which opposes a pitch motion of float member 187, these links convey strong forces which move coupled electromechanical systems in enclosed spaces of the respective float members. That is, pitch motion is efficiently converted to electrical energy when such parallel double links as described are used. Accordingly, some special high-performance couplings between float members may include double rigid links. It is said that a float member is coupled to its neighbor by ‘at least one rigid link’ which is meant to also include double or parallel links as presented here.

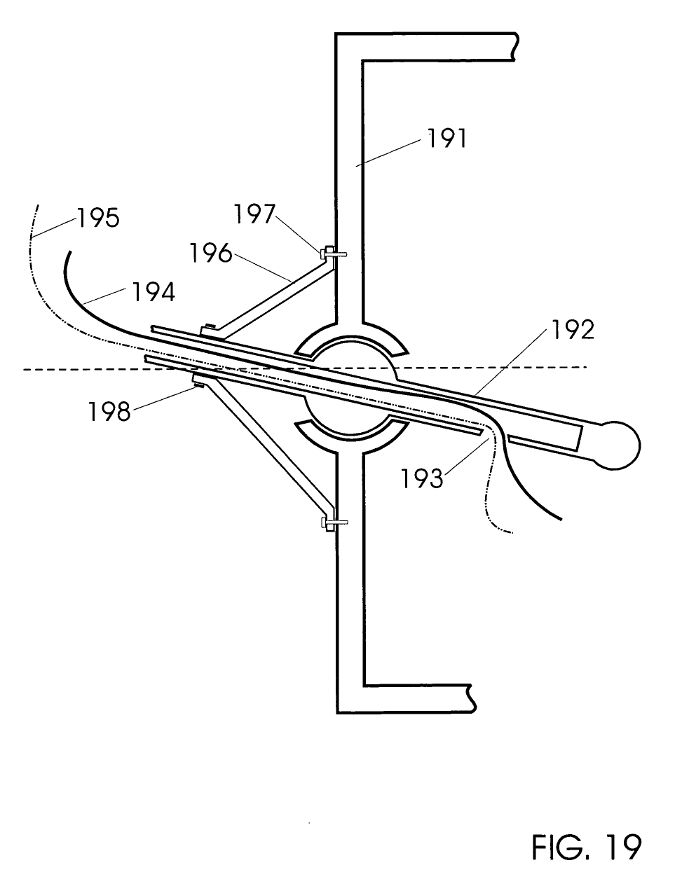

FIG. 19 includes a diagram of certain supporting subsystems of importance. Namely, inter-float electronic coupling subsystems and a flexible ‘boot seal’ subsystem.

Because of these wave energy converters are comprised of a plurality of independently movable float members displaced spatially with respect to each other, and because these float members all operate together to produce a single electric energy output, it is necessary to couple them together electrically as well as mechanically. In addition, some versions include advanced control systems embodied in electronic semiconductor controls, these controls also benefit where certain control signals are passed between float members. It is however undesirable to have exposed electrical lines running between float members because they are easily damaged in the very rough environments of the open sea. Accordingly, some preferred versions of these systems include a rigid link having support for integration of both power and signal electric transmission lines.

A rigid link may be prepared with a hollow core on its axis and an exit port on both ends. Wires, both power and signal wires, may be routed from the enclosed space of a first float member to the enclosed space of a second float member through a hollow core of a rigid link via an exit port therein. The drawing of FIG. 19 includes one example. Float member hull 191 is coupled via integrated ball joint to rigid link 192 which is provided with a hollow core and an exit port 193. Electric power line 194 and electronic signal line 195 are routed through the rigid link hollow core and further through the exit port and into the enclosed space of the float member where the lines may be connected to appropriate electrical subsystems. Although not shown in the drawing, the opposite end of the rigid link may have a similar arrangement which lies within the enclosed space of a second coupled float member. In this way, both power and control signals of each array float member may be coupled to each of the others whereby a single electric power output may be realized as well as centralized system control effected from a single point control server.

In addition to support for electrical coupling between float members, FIG. 19 also illustrates an important seal subsystem. Because the ocean surface is an exceptionally harsh working environment, it is important to protect mechanical systems from the highly corrosive sea components. For this reason, in some versions of these systems, particularly those in which a ball joint includes metal parts, it is important to seal the ball joint from the ocean elements. To bring this about, a ‘boot seal’ 196 is flexible and durable, an example made of thick strong rubberlike materials or compounds, is provided to interface with the float member hull and the rigid shaft providing excellent isolation of the ball joint from the seawater and sea air exposure. The boot seal may be fastened to the side of the float member with strong marine adhesives such as polyurethane described previously, and may in addition be held with bolts or screw type fasteners 197. Similarly, to the circumference of a shaft cross section, the boot seal may be adhered chemically and mechanically. A ‘hose clamp’ mechanism 198 may be tightened on to a collar provided in the boot seal designed to make a durable strong interface with the rigid shaft at shown.

While in general it is desirable to directly convert mechanical motion into electrical energy in these systems, in special circumstance it can be preferable to convert first from mechanical energy to hydraulic pressure and then finally to electricity via a hydraulically driven induction generator. In such special circumstance, induction and other electrical apparatus are removed from these float members and replaced with hydraulic rams and cylinders in communication with hydraulic circuits. A hydraulic circuit is created between cooperating float members, i.e. via the hollow cores of rigid links between float members. A central electric generator which can be stimulated with hydraulic pressure provides the hydraulic circuit load and includes an electrical outlet.

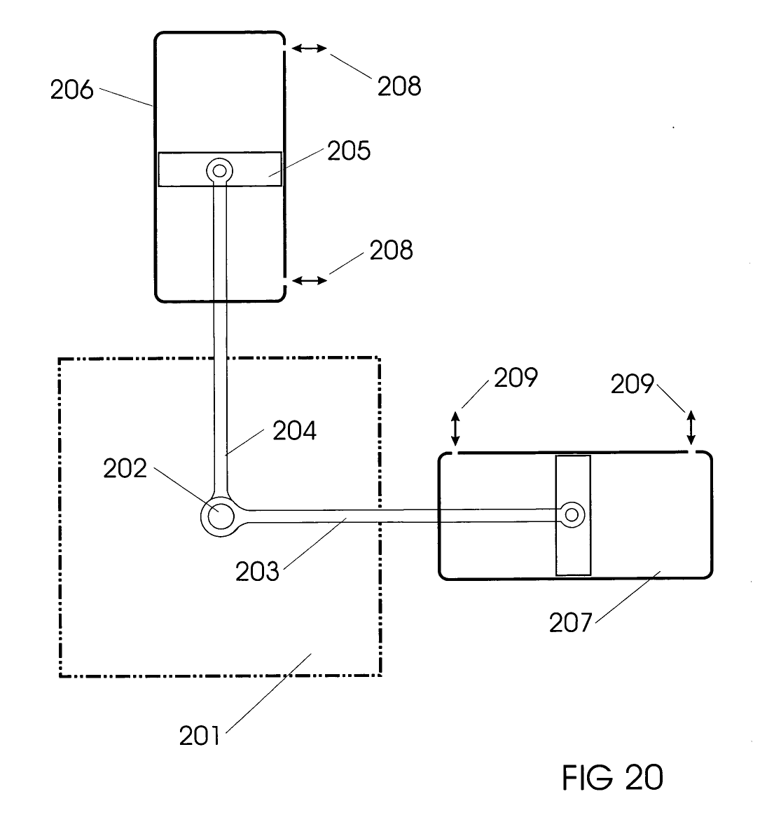

While mechanical systems are similar to those presented in examples previous to this, in these hydraulic versions connecting rods are not coupled to a platter array of magnets, but rather to a hydraulic ram. FIG. 20 shows one such hydraulic system where slide plate 201 by way of drive shaft 202 imparts linear motion in two dimensions to connecting rod 203 (x-direction) and connecting rod 204 (y-direction). The connecting rods are further coupled to a ram 205 which rides in hydraulic cylinder 206 filled with suitable hydraulic fluid. A separate cylinder 207 associated with orthogonal linear motions similarly provides hydraulic pressure to a hydraulic circuit. While not shown, a hydraulic circuit is charged via bi-directional hydraulic pressure 208 while another circuit receives similar bi-directional hydraulic pressure 209 from the other cylinder.

In one important offshore version of these wave energy converters—in particular where the array is far from shore and it is prohibitively impractical to provide a long-distance submarine electric power transmission cable, and energy storage system is provided and coupled to the wave energy converter. ‘Energy’ is stored locally near the wave energy converter in a reservoir. A transport ship arrives periodically to exchange an empty tank with one having been filled over some operational period. In this way, wave energy converters may be deployed at sea far from any shoreline.

In particular, an electrolysis system is arranged between the electrical output of a wave energy converter of this disclosure and a hydrogen storage tank. Electricity generated by the wave energy converter drives electrolysis to produce hydrogen from ocean water which is collected in a storage tank. After sufficient period of time, the tank is filled to capacity. A transport vessel carries an empty tank to sea and couples this tank to the electrolysis system. At the same time, the transport vessel decouples the full tank and delivers useful hydrogen back to land where it may be consumed.

One will now fully appreciate how wave energy converters comprised of a plurality of coupled float members arranged in a two dimensional array will most efficiently absorb energy from passing waves and convert wave kinetic energy to electricity. Although the present invention has been described in considerable detail with clear and concise language and with reference to certain preferred versions thereof including best modes anticipated by the inventors, other versions are possible. Therefore, the spirit and scope of the invention should not be limited by the description of the preferred versions contained therein, but rather by the claims appended hereto.

1) Wave energy converters comprising at least two float members coupled via at least one rigid link, whereby relative motion between said rigid link and float member is converted to electrical energy.

2) Wave energy converters of claim 1, said conversion to electrical energy is by way of at least one induction generator comprising a mover and a stator, either of which is mechanically coupled to either the rigid link or float member whereby motion therebetween produces an electrical current.

3) Wave energy converters of claim 2, motion between said mover and said stator is characterized as a linear motion.

4) Wave energy converters of claim 3,said mover is comprised of an array of magnets, said stator is comprised of an array of inductors, said mover is arranged to move in linear reciprocating motion within a core array of said stator.

5) Wave energy converters of claim 4, said reciprocating linear motion is driven by way of forces from said rigid link.

6) Wave energy converters of claim 2, each of said float members are coupled to a rigid link by way of a two-dimensional pivot coupling.

7) Wave energy converters of claim 6, said two-dimensional pivot coupling is embodied as a ball joint of two portions including a socket portion and a ball portion, said socket portion affixed to or integrated with said float member, said ball portion affixed to or integrated with said rigid link.

8) Wave energy converters of claim 7, said float members comprise a hull which forms a substantially enclosed space, said rigid link comprises a shaft, said shaft extends through said hull and into said enclosed space.

9) Wave energy converters of claim 8, said shaft comprises an end which is free to move about in a spherical section.

10) Wave energy converters of claim 9, further comprising:
a slide plate;
at least two connecting rods; and
at least one magnet array,
said slide plate comprises:
a planar substrate; a receiving socket; and at least one drive shaft,
said planar substrate is free to move within a plane and has affixed thereto said receiving socket and said drive shaft, said receiving socket is arranged to receive therein said shaft end whereby forces from the shaft are conveyed to the slide plate such that it is driven in two dimensional motions within in a plane, said drive shaft extends perpendicularly from the planar substrate and has a circular cross-section,
said at least two connecting rods each and have a circular ring sleeve rotatably coupled to said drive shaft and a second end rotatably coupled to the magnet array,
said magnet arrays are arranged to reciprocate in linear motions as driven by coupled connecting rods.

11) Wave energy converters of claim 10, said magnet arrays comprise:
a substrate platter;
a plurality of extension shafts; and
a plurality of magnets,
said plurality of extension shafts have a first end affixed to the surface of the substrate platter and each has thereon at an opposing end a magnet.

12) Wave energy converters of claim 8, each rigid link is coupled to at least two float members, each rigid link is comprised of at least two ends, each end of each rigid link is arranged within the enclosed space of a float member whereby the rigid link and float member hull have a pivot relationship there between.

13) Wave energy converters of claim 12, each end of each rigid link is coupled to a slide plate restricted to motion in a plane.

14) Wave energy converters of claim 13, said slide plate is comprised of a substrate, receiving socket and drive shaft, said rigid link end is coupled to and confined within said receiving socket whereby shaft rotation about said pivot cause translation in a plane of said slide plate.

15) Wave energy converters of claim 14, said drive shaft is coupled to said mover whereby the drive shaft causes the mover to move in linear reciprocating motion.

16) Wave energy converters of claim 15, said drive shaft is coupled to said mover by a connection rod having a pivot joint on two ends.

17) Wave energy converters of claim 16, said mover is characterized as an array of magnets.

18) Wave energy converters of claim 17, said mover is arranged to be restricted to linear reciprocating motions.

19) Wave energy converters of claim 16, said mover is characterized as an inductor array.

20) Wave energy converters of claim 19, said mover is arranged to be restricted to linear reciprocating motion.

21) Wave energy converters of claim 2, said induction generators are each coupled to a rectifier having a single rectified electric output.

22) Wave energy converters of claim 21, the electric output of said rectifier is electrically coupled to a neighbor float member.

23) Wave energy converters of claim 21, each float member having an electrical output coupled to a submarine power transmission cable between the plurality of float members and a land based power distribution network.

24) Wave energy converters of claim 2, said plurality of float members are anchored to the sea floor and held fast thereto by a mooring system while free to float at the ocean surface.
